(19) United States
(12) Patent Application Publication
(10) Pub. No.: US 2012/0240680 A1
(43) Pub. Date: Sep. 27, 2012

(54) ULTRASONIC SENSOR

(75) Inventors: Hiroshi URASE, Kariya City (JP); Yasushi Nagano, Ise City (JP)

(73) Assignee: Panasonic Corporation, Osaka (JP)

(21) Appl. No.: 13/426,807

(22) Filed: Mar. 22, 2012

(30) Foreign Application Priority Data
Mar. 22, 2011 (JP) 2011-062608

(51) Int. Cl. G01N 29/00

(52) U.S. Cl. 73/632

(57) ABSTRACT

An ultrasonic sensor includes a transceiver block having a transceiver device for transmitting and receiving ultrasonic waves, and a circuit board mounted with an electronic circuit for processing ultrasonic signals transmitted and received through the transceiver device. A housing of the ultrasonic sensor includes a storing portion having an opening. The circuit board is stored within the storing portion, and the opening of the storing portion is closed by the transceiver block.

### FIELD OF THE INVENTION

The present invention relates to an ultrasonic sensor that is mounted on, e.g., a motor vehicle to be used for obstacle detection or the like.

### BACKGROUND OF THE INVENTION

Conventionally, there is available an ultrasonic sensor that includes, as shown in FIG. 3, a hollow housing 101 having an opening on one surface thereof and a transceiver device (transceiver block) 102 having a transceiving surface for transmitting and receiving ultrasonic waves, the transceiving surface exposed on the other surface of the housing 101. The ultrasonic sensor includes a circuit board 103 arranged within the housing 101 and mounted with an electronic circuit for processing ultrasonic waves transmitted and received through the transceiver device 102 and a wiring line 104 electrically interconnecting the transceiver device 102 and the circuit board 103. The ultrasonic sensor further includes a cover member 105 provided to cover the opening of the housing 101 and a terminal 106 connected at one end to the electronic circuit of the circuit board 103 and at the other end to a power supply terminal (not shown).

When used in a motor vehicle, the ultrasonic sensor is installed in a portion highly susceptible to drenching and severe vibrating, e.g., a bumper or a front grill. In many conventional ultrasonic sensors, therefore, a filler material 107 having hydrophobicity and elasticity, such as silicone or urethane, is filled in the housing 101 accommodating the circuit board 103. It is typical that a waterproof property and a vibration resistance are obtained by filling the filler material 107 in the housing 101 in this manner (see, e.g., Japanese Patent Application Publication No. 2005-24351).

In the conventional example stated above, however, the weight and cost of the ultrasonic sensor is proportionately increased as the filler material 107 is filled in the housing 101. In addition, there is a possibility that, due to the existence of the filler material 107, distortions are generated in the circuit board 103 arranged within the housing 101. If the distortions are generated, it is likely that stresses are applied to the solder portions between the circuit board 103 and the electronic parts mounted on the circuit board 103, consequently generating cracks in the solder portions. It is also likely that the sensing area characteristics of the sensor are changed before and after filling the filler material 107. Other causes of generating distortions in the circuit board 103 include, e.g., an external load generated by the thermal expansion and shrinkage of the filler material 107. Examples of the change in the sensing area characteristics before and after filling the filler material 107 include the narrowing of a sensing area of the sensor.

In light of this, as shown in FIG. 4, it may be thinkable to use a seal plate 108 to seal a communication hole 101C through which a board storing portion 101A of a housing 101 for accommodation of a circuit board 103 communicates with a device storing portion 101B of the housing 101 for accommodation of a transceiver device 102. In this configuration, the board storing portion 101A is hermetically sealed by closing the opening of the housing 101 with a cover member 105. It is therefore possible to secure a waterproof property without having to use any filler material.

In case of the conventional example stated above and the configuration shown in FIG. 4, it is however necessary to use the cover member 105 to close the opening of the housing 101. This poses a problem in that the number of parts grows larger. In addition, the costs such as equipment costs are necessarily increased in order to join the cover member 105 to the peripheral edge of the opening of the housing 105. This leads to a problem in that the costs such as depreciation expense grow higher.

### SUMMARY OF THE INVENTION

In view of the above, the present invention provides an ultrasonic sensor capable of securing a waterproof property without having to increase the number of parts, capable of suppressing an increase in weight and cost and capable of preventing generation of distortions in a circuit board.

In accordance with an aspect of the present invention, there is provided an ultrasonic sensor including: a transceiver block having a transceiver device for transmitting and receiving ultrasonic waves; a circuit board mounted with an electronic circuit for processing ultrasonic signals transmitted and received through the transceiver device; a housing including a storing portion having an opening, wherein the circuit board is stored within the storing portion, and the opening of the storing portion is closed by the transceiver block.

The transceiver block may include a cover made of an elastic material and arranged to cover an outer circumferential surface of the transceiver block except for a transceiving surface for transmitting and receiving the ultrasonic waves, the cover making contact with an inner circumferential surface of the storing portion.

With such configurations, the circuit board is stored within the single storing portion and the opening of the storing portion is closed by the transceiver block. It is therefore possible to secure a waterproof property without having to increase the number of parts, to suppress an increase in weight and cost and to prevent generation of distortions in a circuit board.

### BRIEF DESCRIPTION OF THE DRAWINGS

The objects and features of the present invention will become apparent from the following description of embodiments, given in conjunction with the accompanying drawings, in which:

FIG. 1 is a section view showing an ultrasonic sensor according to one embodiment of the present invention;

FIGS. 2A and 2B are section views illustrating different methods of connecting a pin terminal and an outer connection terminal of the ultrasonic sensor, wherein FIGS. 2A and 2B show states before and after the terminal is fitted to a circuit board, respectively;

FIG. 3 is a section view illustrating a conventional ultrasonic sensor; and

FIG. 4 is a section view illustrating another conventional ultrasonic sensor.

### DETAILED DESCRIPTION OF THE PREFERRED EMBODIMENTS

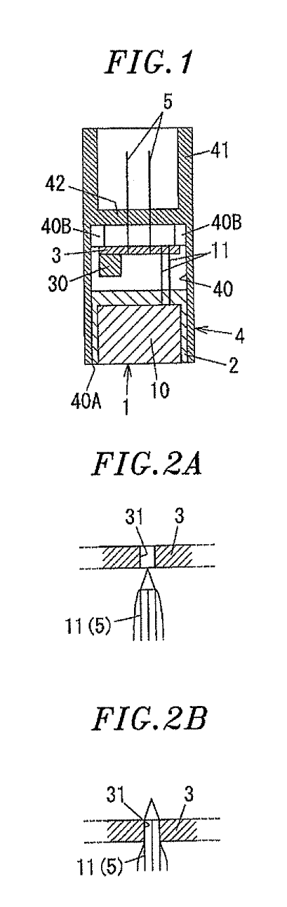

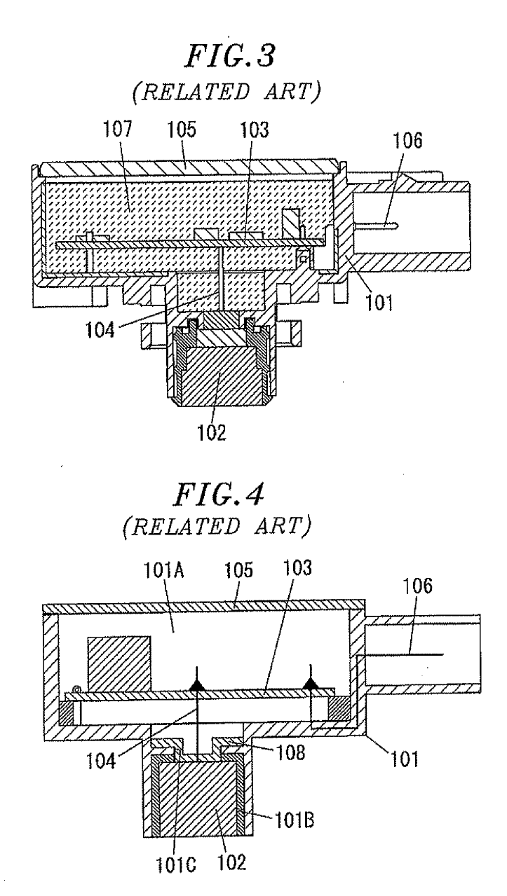

One preferred embodiment of an ultrasonic sensor of the present invention will now be described with reference to the accompanying drawings. In the following description, the upper, lower, left and right sides in FIG. 1 will be defined as upper, lower, left and right directions.

Referring to FIG. 1, the ultrasonic sensor of the present embodiment includes a transceiver block 1 for transmitting and receiving ultrasonic waves, a cover 2 covering the outer circumferential surface of the transceiver block 1 except for the transceiving surface thereof and a circuit board 3 mounted with an electronic circuit for processing ultrasonic signals transmitted and received through the transceiver block 1. The ultrasonic sensor further includes a housing 4 having a storing portion 40 for accommodation of the circuit board 3. The storing portion 40 has an opening 40A. The ultrasonic sensor further includes a pair of outer connection terminals 5 connected at one end to the circuit board 3 and at the other end to external terminals (not shown).

As shown in FIG. 1, the transceiver block 1 includes a transceiver device (not shown), which is formed of a piezoelectric element, and a case 10 for storing the transceiver device therein. The case 10 is made of, e.g., black-colored polybutylene terephthalate, and is formed into a cylindrical shape. The transceiver device is arranged on the inner bottom portion of the case 10. The lower surface of the case 10 is used as a transceiving surface for transmitting and receiving ultrasonic waves.

The transceiver block 1 includes a lead line (not shown) electrically connected at one end to the transceiver device and a pair of rod-shaped pin terminals 11 soldered at one end to the lead line and protruding at the other end to the outside of the case 10. The other end of each of the pin terminals 11 is electrically connected to an electronic circuit mounted to the circuit board 3.

As shown in FIG. 1, the cover 2 is made of an elastic material and is formed into a cylindrical open-bottom shape with the lower surface thereof opened. The cover 2 is fixed to the outer circumferential surface of the case 10 to cover the transceiver block 1. Through-holes (not shown) for allowing the pin terminals 11 of the transceiver block 1 to pass therethrough are formed in the upper surface of the cover 2.

As shown in FIG. 1, the circuit board 3 is fixed to the upper bottom portion of the storing portion 40 of the housing 4. The pin terminals 11 are connected to the circuit board 3 by soldering. Electronic parts 30 making up the electronic circuit are mounted on the lower surface of the circuit board 3. In addition to the electronic parts 30 shown in FIG. 1, other electronic parts having different sizes are mounted on the lower surface or the upper and lower surfaces of the circuit board 3. The circuit board 3 is bonded to the upper bottom portion of the storing portion by a bonding method using an adhesive agent or other methods.

As shown in FIG. 1, the housing 4 includes the cylindrical storing portion 40 having a bottom and an opening, the circuit board 3 being stored within the storing portion 40; and a connector portion 41 having a pair of outer connection terminals 5. The circuit board 3 is stored into the storing portion 40 through the opening 40A of the storing portion 40. The opening 40A is closed by the transceiver block 1. The transceiver block 1 having the cover 2 fixed thereto is inserted into the opening 40A and is attached to the housing 4 with the transceiving surface thereof exposed to the outside. In this regard, the outer diameter of the cover 2 is a little larger than the inner diameter of the storing portion 40. Therefore, when inserting the transceiver block 1, the cover 2 is press-fitted to the storing portion 40 and is joined to the inner circumferential surface of the storing portion 40.

Inasmuch as the opening 40A of the storing portion 40 is closed by the transceiver block 1 with the circuit board 3 isolated from the outside by the transceiver block 1, it is possible to prevent water from infiltrating into the circuit board storing space from the outside through the opening 40A.

As shown in FIG. 1, a pair of support ribs 40B is formed in the left and right end portions of the bottom portion of the storing portion 40 in such as fashion as to protrude downward. The circuit board 3 is fixed to the bottom portion of the storing portion 40 in a state that the left and right end portions of the circuit board 3 make contact with the lower surfaces of the support ribs 40B.

The outer connection terminals 5 are one-piece molded with the housing 4 by insert-molding in such as fashion as to extend through the wall 42 of the bottom portion of the storing portion 40. Each of the outer connection terminals is provided to protrude to the outside of the storing portion 40 at one end and to protrude into the storing portion 40 at the other end. One ends of the outer connection terminals 5 are connected to external terminals (not shown). The other ends of the outer connection terminals 5 are electrically connected to the electronic circuit mounted on the circuit board 3.

Referring to FIGS. 2A and 2B, the other ends of the pin terminals 11 and one ends of the outer connection terminals 5 are formed to have resilience and are inserted, by press-fit, into insertion holes 31 formed in the circuit board 3. Thus the other ends of the pin terminals 11 and one ends of the outer connection terminals 5 are electrically connected to the electronic circuit. This eliminates the need to solder the pin terminals 11 and the outer connection terminals 5 to the electronic circuit, thereby making it possible to enhance the manufacturability.

The electronic circuit of the circuit board 3 is supplied with electric power from an external power supply (not shown) through the outer connection terminals 5. The electronic circuit outputs a drive pulse signal to the transceiver device. Responsive to the drive pulse signal, the transceiver device transmits ultrasonic waves to the outside. If the transceiver device receives ultrasonic waves reflected from an obstacle, the transceiver device outputs a wave receiving signal to the electronic circuit of the circuit board 3. The electronic circuit of the circuit board 3 calculates the distance to the obstacle by measuring the time taken until the wave receiving signal is inputted after outputting the drive pulse signal. Then, the electronic circuit outputs a signal indicating the calculation result to an external control circuit (not shown) through the outer connection terminals 5.

In the present embodiment described above, the circuit board 3 is stored within the storing portion 40 and the opening 40A of the storing portion 40 is closed by the transceiver block 1. Since a filler material which may apply stresses to the circuit board 3 does not exist around the circuit board 3, it is possible to suppress an increase in weight and cost while securing a waterproof property and to prevent generation of distortions in the circuit board 3. Unlike the conventional example, it is not necessary for the housing 4 to have a board storing portion for accommodation of the circuit board 3. There exists no opening other than the opening 40A of the storing portion 40. Since it is not necessary to additionally provide a cover member for closing an opening, it is possible to reduce the number of parts. In addition, the circuit board 3 and the upper bottom portion of the storing portion 40 are joined to each other by a method other than welding, e.g., a bonding method using an adhesive agent. This eliminates the need to use welding equipment. Thus there is no need to make an initial investment such as an investment for equipments. It is therefore possible to reduce the fixed costs such as depreciation expense.

In the present embodiment, the cover 2 made of an elastic material is arranged on the outer circumferential surface of the transceiver block 1 except for the transceiving surface and the cover 2 makes contact with the inner circumferential surface of the storing portion 40. Since the gap between the transceiver block 1 and the inner circumferential surface of the storing portion 40 can be filled by the cover 2 with no clearance, it is possible to reliably close the opening 40A as compared with a case where the opening 40A of the storing portion 40 is closed by only the transceiver block 1.

While the invention has been shown and described with respect to the embodiments, it will be understood by those skilled in the art that various changes and modification may be made without departing from the scope of the invention as defined in the following claims.

What is claimed is:

1. An ultrasonic sensor, comprising:
a transceiver block having a transceiver device for transmitting and receiving ultrasonic waves;
a circuit board mounted with an electronic circuit for processing ultrasonic signals transmitted and received through the transceiver device;
a housing including a storing portion having an opening,
wherein the circuit board is stored within the storing portion, and the opening of the storing portion is closed by the transceiver block.

2. The ultrasonic sensor of claim 1, wherein the transceiver block includes a cover made of an elastic material and arranged to cover an outer circumferential surface of the transceiver block except for a transceiving surface for transmitting and receiving the ultrasonic waves, the cover making contact with an inner circumferential surface of the storing portion.
